(19) United States
(12) Patent Application Publication
(10) Pub. No.: US 2007/0025583 A1
(43) Pub. Date: Feb. 1, 2007

(54) Sound dispersion speaker grill

(76) Inventor: Robert P. Weil, Thompsons Station, TN (US)

Correspondence Address: Robert P. Weil, 2804 Stacey Street, Thompsons Station, TN, 37179, US

(21) Appl. No.: 11/193,492

(22) Filed: Aug. 1, 2005

(51) Int. Cl. H04R 1/02

(52) U.S. Cl. 381/391

(57) ABSTRACT

The invention described herein is an externally mounted speaker grill with special features for dispersing full range sound at broad angles. The basic form of the invention consists of a speaker grill for protecting a speaker from the elements, a rounded cone shaped feature for dispersing high-frequency sound waves at broad angles, a series of spoke features for supporting the cone feature while allowing full range sound waves to pass largely unhindered, and mounting holes for screws to affix the speaker grill to the front of a speaker mounting board in front of a speaker.

### BACKGROUND

1. Field of Invention

This invention relates to speaker grills, specifically to an improved design for dispersing high-frequency sound waves from the center of a full range speaker to broad angles beyond the range of conventional full range speakers.

2. Discussion of Prior Art

Speaker grills of various styles and materials have been in existence for many years. Some are no more than cloth coverings, attached to the front of a speaker enclosure by varying means, for both protective and decorative reasons. While protecting the speaker from the elements, cloth actually diminishes the speaker output and perceived high-frequency sound. Metal mesh has also been used which provides some protection from the elements, but still blocks up to 50% of the sound coming out of the speaker and, like cloth, does nothing to disperse the very directional high-frequency sound waves coming out of the middle part of the speaker.

Previous inventions for sound dispersion speaker grills concentrate only on tweeter speakers, not full range speakers, and are typically built in as part of the speaker itself, rather than being an externally attached device.

Surprisingly, no externally attachable speaker grills for full range speakers currently or previously on the market address the issue of sound dispersion for these typically uni-directional types of speakers.

### OBJECTS AND ADVANTAGES

The objects and advantages of my invention are as follows:

(a) The invention provides a simple, attractive, and low-cost method to provide sound dispersion for full range speakers, particularly speakers used for musical instrument amplifiers;

(b) The sound dispersion speaker grill is designed with screw holes so it can be externally attached to the speaker mounting board which holds a speaker in the speaker cabinet, enabling a user to attach the speaker grill to any appropriately sized speaker cabinet;

(c) A rounded cone feature is integrated into the back of the speaker grill to block the overly bright high-frequencies emanating from the center of the speaker while directing the pleasant sounding high-frequencies from the area immediately surrounding the center of the speaker to broad angles where those high-frequency sounds are normally not heard;

(d) Spokes in the grill are tapered inward, toward the speaker, so that very little sound is blocked. These spoke features also facilitate the dispersion of high-frequency sound waves in conjunction with the rounded cone feature;

(e) For musical instrument amplifier applications, the sound dispersion speaker grill enables the musician to be almost anywhere on the stage and be able to hear the same quality of sound in each place.

Further objects and advantages of my invention will become apparent from a consideration of the drawings and ensuing description.

### DRAWING FIGURES

FIG. 1 is a front perspective view of my invention, shown mounted on a speaker mounting board.

FIG. 2 is a rear perspective view of my invention.

FIG. 3 is a side view line drawing of my invention, showing all internal and external lines of the invention, speaker mounting board, and speaker.

### REFERENCE NUMERALS IN DRAWINGS

1 The invention as a whole

2 Speaker mounting board

3 Center high-frequency blocking hub

4 Contoured spokes

5 Sound dispersion cone

6 Mounting screw holes

7 Speaker

### DESCRIPTION OF INVENTION

The following detailed description illustrates the invention by way of example and not by way of limitation of the principles of the invention. The example shown may or may not be the best embodiment of the invention, but is merely the first embodiment to be made and tested. Anyone skilled in the art will be able to assemble their own particular design, based on the invention, using materials and which are already in use today.

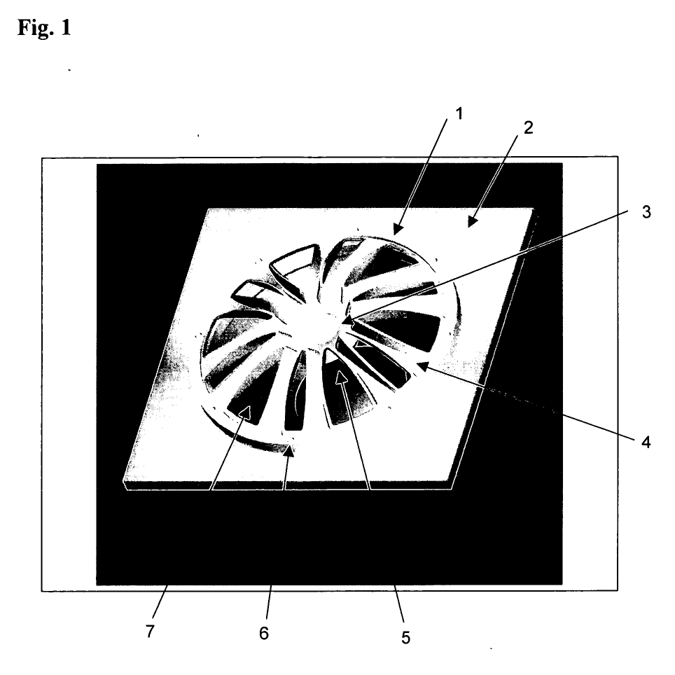

FIG. 1 shows a front perspective view of the current embodiment of the invention 1. Tapered spokes 4 radiate from the center high-frequency blocking hub 3, giving the appearance of an automobile hubcap or wheel. A sound dispersion cone 5 protrudes from the rear of the center high-frequency blocking hub 3. The invention is typically mounted over a speaker 7 onto a speaker mounting board 2 by means of a series of screws fitted through mounting screw holes 6 and screwed into the speaker mounting board 2.

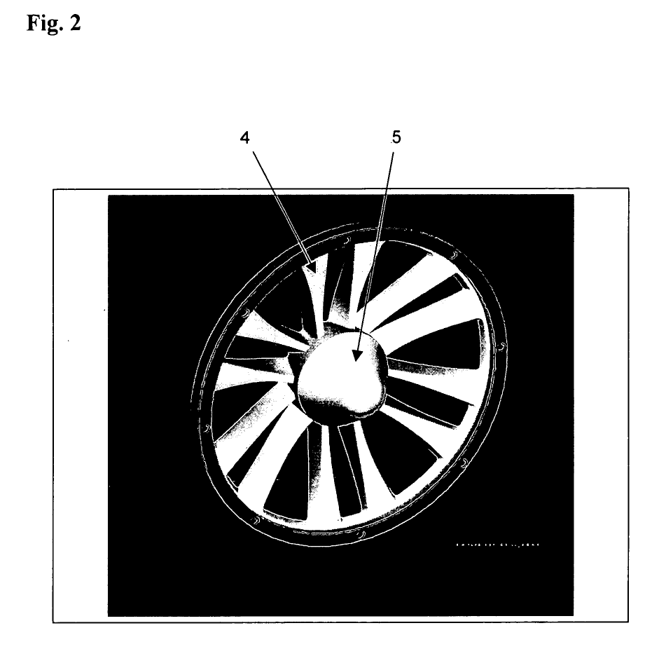

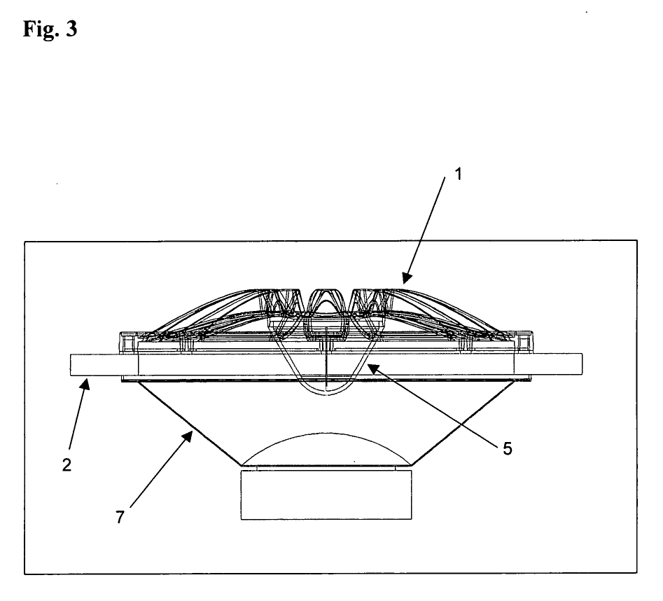

FIG. 2 is a rear perspective view of the current embodiment of the invention 1. This view more clearly illustrates the tapered spokes 4 and sound dispersion cone 5. When sound comes from the speaker 7 (see FIGS. 1 and 3), the high-frequency sound waves from the center of the speaker are partially blocked by the sound dispersion cone 5 and center high-frequency blocking hub 3 (see FIG. 1). Much of the remaining high-frequency sound waves, along with mid-range frequency sound waves, are directed by the sound dispersion cone 5 and tapered spokes 4 to wide angles, increasing the effective listening angle from approximately 45° for a normal speaker without the invention 1, to nearly 180° for a normal speaker with the invention 1.

FIG. 3 is a side view line drawing of my invention 1, showing all internal and external lines of the invention 1, speaker mounting board 2, and speaker 7. It also illustrates how the sound dispersion cone 5 protrudes toward the speaker 7.

### CONCLUSION, RAMIFICATIONS, AND SCOPE

At this point, it should be noted that the specific design of the component parts described in FIGS. 1, 2, and 3 are not of particular importance since sound dispersion speaker grills can be manufactured in various forms. The uniqueness of this invention is the combination of external mounting ability with sound dispersion characteristics brought about by use of a rounded cone feature and tapered spoke features. The sound dispersion cone can be designed in various angles and is not limited to 60 degrees, although that angle seems to work very well. The spokes can be varied in number and angle of taper. The speaker grill as a whole can be made for any size full range speaker.

The scope of this invention may include, but should not be limited to, the following applications for speaker grills: Guitar amplifier and/or speaker cabinet, Bass amplifier and/or speaker cabinet, Keyboard amplifier and/or speaker cabinet, other instrument amplifier and/or speaker cabinet, PA system speakers whether powered or passive. In any of these embodiments, the sound dispersion speaker grill can broaden the angle of full range sound far beyond that of the speaker itself.

Thus the scope of the invention should be determined by the appended claims and their legal equivalents, rather than by the examples given.

I claim:

1. A speaker grill comprising:
an externally mounted device for covering a speaker;
a rounded cone shaped feature in the center of said speaker grill, pointing toward said speaker, for the purpose of distributing high-frequency sound waves at broad angles from said speaker;
spoke features emanating from the center of said speaker grill with the surfaces facing said speaker being tapered inward toward said speaker.
